(19) United States
(12) Patent Application Publication
(10) Pub. No.: US 2015/0124260 A1
(43) Pub. Date: May 7, 2015

(54) OPTICAL DEVICE FOR INTERFEROMETRIC ANALYSIS OF THE CONDITION OF THE INTERNAL SURFACE OF A TUBE

(71) Applicants: Joël CHEVRIER, SAINT EGREVE (FR); Serge HUANT, VARCES (FR)

(72) Inventors: Joël CHEVRIER, SAINT EGREVE (FR); Serge HUANT, VARCES (FR)

(73) Assignee: Universite Joseph Fourier, Grenoble (FR)

(21) Appl. No.: 14/238,897

(22) PCT Filed: Aug. 13, 2012
(86) PCT No.: PCT/FR2012/051886

§ 371 Date: May 19, 2014

(30) Foreign Application Priority Data
Aug. 16, 2011 (FR) 11/57347

(51) Int. Cl. G01B 11/24; G02B 6/26; G01B 11/12

(52) U.S. Cl. CPC G01B 11/2441; G01B 11/12; G02B 6/262
USPC 356/477

(57) ABSTRACT

The invention relates to an optical device for interferometric analysis of the condition of the internal surface of a tube (11). The device comprises an optical fibre (3), the free end of which is pointed and then bevelled at the single core thereof and the bevelled surface is metalised (10), such that only part of the surface of the fibre core participates in reflecting the incident beam perpendicularly to the axis of the fibre.

### CROSS-REFERENCE TO RELATED APPLICATION

This application is a National Stage of PCT International Application Serial Number PCT/FR2012/051886, filed Aug. 13, 2012, entitled “Optical Device for Interferometric Analysis of the Condition of the Internal Surface of a Tube”, which claims priority under 35 U.S.C. §119 of French Patent Application Serial Number 11/57347, filed Aug. 16, 2011, the contents of which is hereby incorporated by reference in its entirety to the maximum extent allowable by law.

### BACKGROUND

The present invention relates to a device for analyzing the internal surface condition of a tube, and in particular of a tube having a small inner diameter.

### Discussion of the Related Art

Devices for measuring the inner diameter of a tube, such as that described in US patent application 2010/0220369, which use conventional optical systems with lenses, are known. US patent application 2010/0220369 provides reflecting light orthogonally to the direction of a main beam by adding a mirror system. Such devices do not enable to perform measurements in tubes having very small diameters and with a very high definition.

Further, there exist optical interferometric analysis devices which enable to measure the roughness of a surface with an accuracy in the order of one nanometer. An example of such a device is described in French patent application No. 0859091 (B9031) of the applicants.

FIG. 1 is a copy of FIG. 1 of the above-mentioned patent application. An optical source 1 sends a light beam, for example, a laser beam, onto surface 2 of an object to be analyzed via an optical fiber 3 comprising a core 4 and an optical cladding 5. The laser beam forms a light spot on object 2. The light beam is reflected into the fiber, on the one hand, by end surface 7 of the fiber, and on the other hand by object 2, towards a beam splitter 8 and a detector 9. Thus, at the detector level, an interference between the light reflected by the end of the fiber and the light reflected by the object can be observed.

If the surface of the object is generally orthogonal to the axis of the beam at the fiber output, and if the fiber is displaced so that its end remains in a plane parallel to the plane of the object, a variation of the interference pattern can be observed, which variation enables to determine the topography of the object

Such a device enables to accurately analyze the condition of planar surfaces. It would be desired to be able to analyze the internal surface of a tube with the same accuracy.

### SUMMARY

Thus, an object of an embodiment of the present invention is to provide a device capable of measuring the topography of the internal surface of a tube having a very small diameter with a very high resolution.

Another object of an embodiment of the present invention is to provide a simple device compatible with existing optical fiber interferometric analysis devices.

Thus, an embodiment of the present invention provides an optical device for the interferometric analysis of the condition of the internal surface of a tube, comprising an optical fiber having a pointed free end, which is beveled at the level of its core only, the beveled surface being metallized, so that only part of the fiber core surface takes part in reflecting the incident beam perpendicularly to the fiber axis.

According to an embodiment of the present invention, the metallization material is gold.

According to an embodiment of the present invention, the device further comprises interference signal filtering means removing frequencies resulting from the displacement of the optical fiber.

The present invention provides a method of interfero-metric analysis of the condition of the internal surface of a tube, comprising the steps of introducing an end of an optical fiber into the tube, the fiber end being pointed, and then beveled at the level of its core only, the beveled surface being metallized, so that only a portion of the fiber core surface takes part in reflecting the incident beam perpendicularly to the fiber axis; laterally and rotatably displacing the optical fiber; and detecting the interference signal between a light wave reflected by the optical fiber and a wave reflected by the internal surface of the tube.

According to an embodiment of the present invention, the device further comprises a step of filtering the interference signal to remove frequencies resulting from the displacement of the optical fiber.

### BRIEF DESCRIPTION OF THE DRAWINGS

The foregoing and other objects, features, and advantages will be discussed in detail in the following non-limiting description of specific embodiments in connection with the accompanying drawings, among which:

FIG. 1, previously described, schematically shows an optical device of interferometric analysis of the topography of a surface to be analyzed,

FIG. 2 shows the end of an optical fiber of an optical device of interferometric analysis of the topography of the internal surface of a tube,

FIG. 3 shows an alternative embodiment of an optical device of interferometric analysis of the topography of the internal surface of a tube, and

FIGS. 4A and 4B illustrate a device of interfero-metric analysis of the topography of the internal surface of a tube according to an embodiment of the present invention.

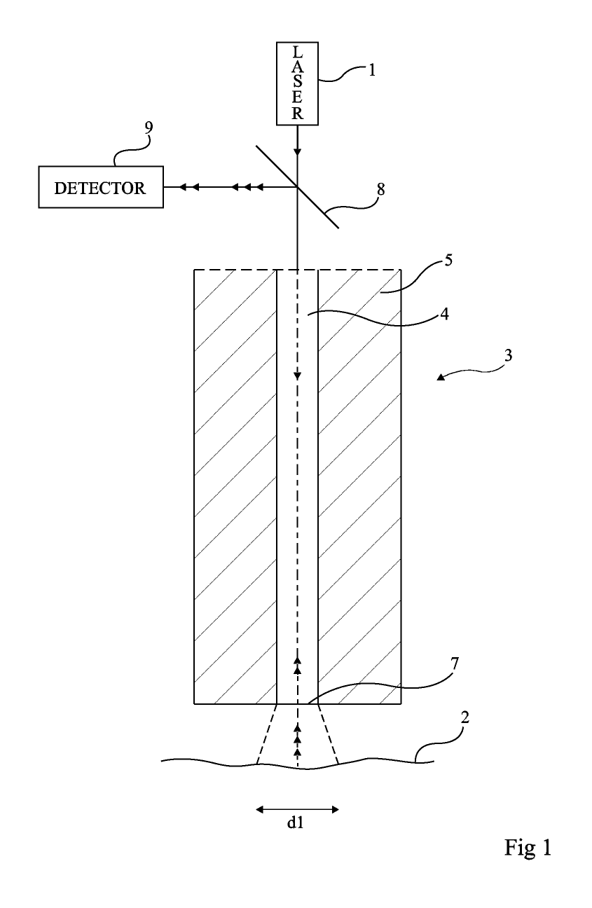

### DETAILED DESCRIPTION

For clarity, the same elements have been designated with the same reference numerals in the various drawings and, further, the various drawings are not to scale.

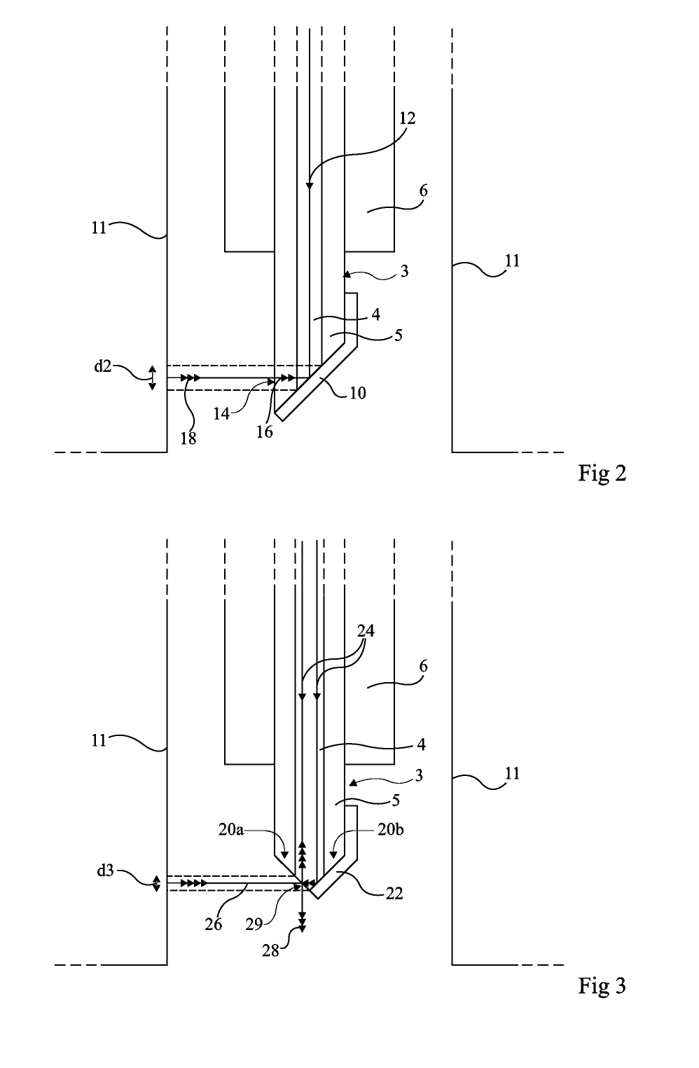

FIG. 2 shows the end of an optical fiber of an optical device of interferometric analysis of the topography of the internal surface of a tube. An optical fiber 3, a single end of which is shown, comprises a core 4, an optical cladding 5 surrounding core 4, and a protection cladding 6 surrounding optical cladding 5. The end of the optical fiber is stripped by removal of a portion of the protection cladding to form a stripped optical fiber portion. Core 4 and optical cladding 5 are for example made of silicon oxides of different dopings. The end of the stripped optical cladding is beveled according to an angle close to 45°. The bevel is covered with a reflective layer 10, for example, a metal layer and more specifically a gold layer. To form the reflective layer on the bevel, the end of the stripped optical fiber may for example be exposed to an evaporation or spraying source. The evaporation and the spraying being directional, all the surfaces of the stripped optical fiber facing the source are covered by the reflective layer, as illustrated in the drawing.

Generally, before the deposition of the reflective layer, a bonding layer, for example, made of chromium or of titanium, will be deposited, and the reflective layer may be made of gold or aluminum.

It should be noted that the light-reflection mode of FIG. 2 is particularly advantageous over prior structures, such as for example described in US patent application 2010/0220369. Indeed, it is avoided to add a reflection mirror to the existing system, such a reflection mirror being incorporated to the fiber by its beveling, as indicated hereabove.

The end of the optical fiber is placed in a tube 11, which is the object having an internal surface desired to be analyzed. Optical fiber 3 is positioned in tube 11 so that the fiber axis is substantially confounded with the tube axis.

To measure the topology of the internal surface of tube 11, a light beam 12, for example, that of a laser emitting in the visible range, is injected into optical fiber 3. At the end of the optical fiber shown in FIG. 2, the beam is reflected by reflective layer 10 and propagates transversely to the axis of the optical fiber in the direction opposite to the bevel. The beam forms a light spot of height d2 on the internal surface of the tube. The beam is reflected into the fiber, on the one hand, by interface 14 between the optical fiber and air, and on the other hand by tube 11. Thus, an interference pattern between the light waves 16 reflected by the optical fiber and the light waves 18 reflected by the tube can be observed.

The variation of the interference pattern on displacement of the optical fiber laterally and rotatably along the axis of tube 11 can be measured. The displacement of interference fringes translates the distance variation between the beveled end of the optical fiber and the analyzed surface. Thus, a measurement of the topology of the internal surface of the tube is obtained.

Just like other devices of interferometric analysis of the surface of an object, the device provided herein has a resolution in the order of a few nanometers for radial distances between the cut end of the optical fiber and the analyzed surface. The spatial resolution, that is, in the directions of the illuminated surface of the tube, is substantially equal to the size of the light spot, that is, substantially the size of core 4 of the optical fiber (currently from 3 to 5 μm for a fiber capable of guiding visible light).

According to the present invention, means for obtaining a light spot having a size smaller than that set by the diameter of the fiber core are provided.

FIG. 3 illustrates a first variation of the embodiment illustrated in FIG. 2, aiming at improving the spatial resolution. An optical fiber 3 is cut to form a double bevel. The double bevel is formed of two symmetrical bevels 20a and 20b in the shown example. A reflective layer 22 covers bevel 20b. Conversely to what is shown in the drawing, the angle formed by the two bevels is selected so that the portion of the light beam reflecting on bevel 20b comes out of the fiber orthogonally to the axis thereof

At the end of the optical fiber, an incident laser beam 24 is divided into a beam 26 reflected on bevel 20b and a beam 28 transmitted through bevel 20a. Only reflected beam 26 is useful to the interferometric analysis of the internal surface of the tube. It will be ascertained that transmitted beam 28 is not sent back into the fiber.

Beam 26, reflected by bevel 20b, is submitted to a refraction at its coming out of bevel 20a. Reflected beam 26 forms a light spot of height d3 on the internal surface of the tube. The light beam is sent into the fiber, on the one hand, by interface 29 between core 4 and air, on the other hand by tube 11.

In the variation provided in relation with FIG. 3, the spatial resolution of the device is increased with respect to that of the device illustrated in FIG. 2. Indeed, height d3 of the light spot on the tube is divided by two with respect to height d2 since only half of the laser beam is reflected on layer 22. Thus, by limiting the reflection surface having the incident beam reflected thereon towards the surface to be analyzed, the equivalent of a diaphragm which limits the dimensions of the light spot on the tube surface is achieved.

The double bevel of the end of the fiber may be asymmetrical. In this case, if the metallized bevel is that having the smallest surface area, the spatial resolution is further increased.

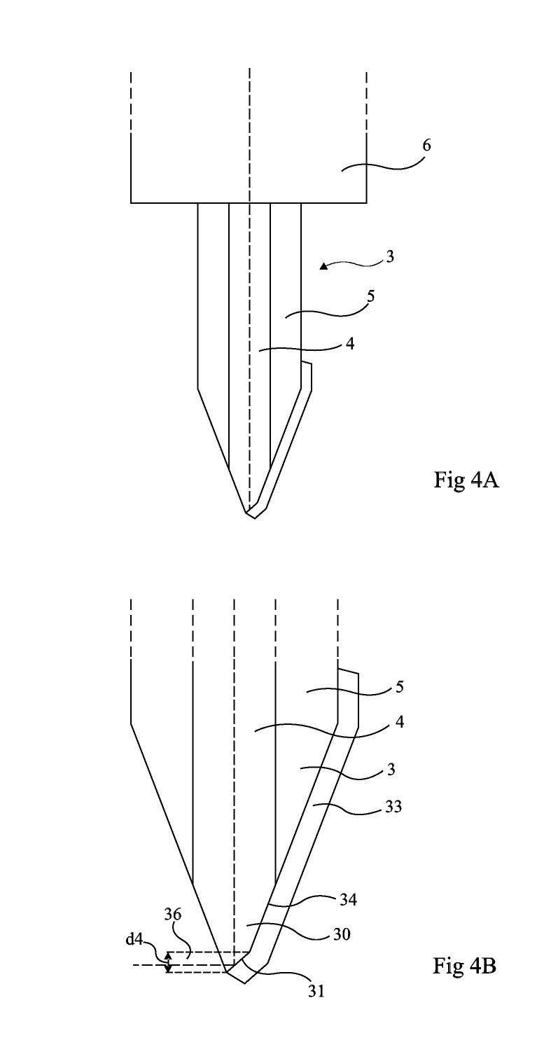

FIGS. 4A and 4B, FIG. 4B being an enlarged view of a portion of FIG. 4A, illustrate a second variation of the embodiment illustrated in FIG. 2, also aiming at improving the spatial resolution according to an embodiment of the present invention. As previously, the end of an optical fiber 3 comprising a core 4, an optical cladding 5 surrounding the core, and a protection cladding 6 surrounding optical cladding 5, has been shown, the end of the optical fiber being stripped by removal of a portion of the protection cladding to form a stripped fiber portion.

In this embodiment, the fiber is given a very pointed shape so that a pointed end 30 of core 4 distinctly protrudes from the limit of optical cladding 3. Then, the fiber is cut to form a flat area 31 on pointed end 30 of core 41 only, as shown. Then, as previously, a reflection layer 33 is formed in directional fashion to cover the side of the fiber comprising flat area 31. The angle of flat area 31 is selected so that the light arriving into the optical fiber and hitting flat area 31 reflects to form an output beam 36 orthogonal to the general direction of the fiber. However, the light reaching portion 34 of the core is lost (it reflects in directions from which it will not be sent back into the fiber). Output beam 36 has a diameter d4 which, as will be understood, may be set in chosen manner according to the distance to the tip of the fiber at which the flat area has been formed. In practice, dimensions in the order of half the wavelength of the incident light may be provided for reflective surface 31.

Although this is not shown in FIGS. 3 and 4B, it should be understood that, as it comes out of the fiber, the beam is deflected under the effect of refraction. The angle of the reflective surfaces (20b, 31) will be selected so that the output beam is effectively at a 90° angle with respect to the fiber axis, taking the deflection into account.

From a mechanical point of view, it can be observed that it is in practice impossible to center the optical fiber in the tube with the required accuracy, which should be at least equivalent to the resolution of the device, that is, a few nanometers. In a measurement by the device described herein, the optical fiber is rotated at constant speed. If the fiber is off-centered, a distance variation between the fiber and the tube appears during the rotation, even if the tube has a perfectly regular relief. In other words, the measured interference signal is modulated by the rotation frequency of the fiber. To do away with this measurement error, means for filtering the interference signal are provided to remove the optical fiber rotation frequency. The filtering means may for example be a high-pass filter, since the signals corresponding to the topology of an analyzed surface have a high frequency with respect to the rotation frequency of the fiber. The filtering may be performed with a signal processing software.

Currently, the diameter of a stripped optical fiber is in the order of 100 μm, and the diameter of the protection cladding is in the range from 250 to 600 μm. If the tube has a very small diameter, only the stripped end of the fiber is introduced therein. The device provided herein can perform measurements on tubes having an internal diameter smaller than one millimeter.

The device provided herein enables to perform measurements on tubes having highly variable lengths, from a few millimeters to a few centimeters, such as for example syringes or catheters.

The processing of the interference signal has not been detailed, since, except for the means for removing the parasitic components linked to the rotation of the fiber, this processing is similar to that used in conventional systems of interfero-metric analysis of the surface condition of a planar surface. The various alternative processings described in such conven-tional systems may apply, mutatis mutandis, to a device such as described herein.

Specific embodiments of the present invention have been described. Various alterations and modifications will occur to those skilled in the art. In particular, the laser emission wavelength, the type of optical fiber, and the material of the reflective layer will be selected according to the desired performance of the device. Further, although a rotating and shifting displacement of the fiber with respect to the tube has been described, it may be simpler to displace the tube with respect to the fiber.

1. An optical device for the interferometric analysis of the condition of the internal surface of a tube, comprising an optical fiber having a pointed free end, which is beveled at the level of its core only, the beveled surface being metallized, so that a portion only of the fiber core surface takes part in reflecting the incident beam perpendicularly to the fiber axis.

2. The device of claim 1, wherein the metallization material is gold.

3. The device of claim 1, further comprising means for filtering the interference signal removing frequencies resulting from the displacement of the optical fiber.

4. A method of interferometric analysis of the condition of the internal surface of a tube, comprising the steps of:
introducing an end of an optical fiber into the tube, the end of the fiber being pointed, and then beveled at the level of its core only, the beveled surface being metallized, so that a portion only of the fiber core surface takes part in reflecting the incident beam perpendicularly to the fiber axis;
laterally and rotatably displacing the optical fiber; and
detecting the interference signal between a light beam reflected by the optical fiber and a beam reflected by the internal surface of the tube.

5. The method of claim 4, further comprising a step of filtering the interference signal to remove frequencies resulting from the displacement of the optical fiber.

6. The device of claim 2, further comprising means for filtering the interference signal removing frequencies resulting from the displacement of the optical fiber.
